(19) United States
(12) Patent Application Publication
(10) Pub. No.: US 2005/0159900 A1
(43) Pub. Date: Jul. 21, 2005

(54) System and method for identifying structures for a chemical compound

(76) Inventor: Robert S. Pearlman, Austin, TX (US)

Correspondence Address: SPRINKLE IP LAW GROUP, 1301 W. 25TH STREET, SUITE 408, AUSTIN, TX, 78705, US

(21) Appl. No.: 10/994,193

(22) Filed: Nov. 19, 2004

Related U.S. Application Data
(60) Provisional application No. 60/523,972, filed on Nov. 21, 2003.
(60) Provisional application No. 60/524,138, filed on Nov. 21, 2003.

(51) Int. Cl. G06F 19/00

(52) U.S. Cl. 702/27

(57) ABSTRACT

Embodiments of the present invention provide a system and method for determining the structures of a chemical compound. Generally, embodiments of the present invention can provide a computer executable program that, for a given compound, can derive any number of additional structures for the compound from an input structure. The additional structures can include all proto-stereomers, or any subset thereof, of the compound (i.e., all or a set of stereomers for all or a set of protomers). The proto-stereomers can be determined based on all the protomers for the compound, a plausible set of protomers or any subset of the protomers for the compound.

### RELATED APPLICATIONS

This application claims benefit of U.S. Provisional Patent Application No. 60/523,972, entitled “System and Method for Structural Representations of Chemical Compounds,” by Robert S. Pearlman, filed Nov. 21, 2003 and U.S. Provisional Application No. 60/524,138, entitled “System and Method for Providing Canonically Unique Structural Representation of Chemical Compounds,” by Robert S. Pearlman, each of which is fully incorporated by reference herein. This application is related to U.S. patent application Ser. No. ______, entitled “System and Method for Providing a Canonical Structural Representation of Chemical Compounds,” by Robert S. Pearlman, filed Nov. 19, 2004, which is hereby fully incorporated by reference herein.

### FIELD OF THE INVENTION

Embodiments of the present invention are related to computer based representations of molecular structures. More particularly, embodiments of the present invention are related to systems and methods for identifying structures for a chemical compound.

### BACKGROUND

In the real (Natural) world, each chemical compound can exist in multiple “protomeric states” (reflecting different “protonation states” and different “tautomeric states”). As a compound is transformed from one protomeric state to another, it can also exist in multiple “stereomeric states” (reflecting different atom-centered chiralities and different bond-centered chiralities). These various protomeric and stereomeric possibilities correspond to the various possible structures for a given chemical compound. In contrast, in the in silico world (i.e. in a computer), each chemical compound is currently represented as a single structure. The real world (Natural) behavior of each chemical compound is a consequence of one or more structures amongst all possible structures which that compound could adopt. Thus, unless computer-based representations of chemical compounds and computer-based models of compound properties are based on the same range of structures as are available to the compound in the real (Natural) world, in silico representations and models of chemical compounds will be deficient.

Current in silico representations of chemical compounds and models of chemical properties fail to represent the range of structures available to those compounds in the real world. This adversely impacts efforts to model (predict or understand) both physical chemical and biochemical properties of chemical compounds. This also adversely impacts the ability to identify compounds for scientific purposes (finding compounds in databases or in the literature) and for purposes related to intellectual property rights (patents). The invention described herein alleviates those problems.

Software programs have been written to address the fact that chemical compounds can exist in multiple protomeric states. However, that software has invariably failed to address the fact that transformation from one protomeric state to another often induces a change in stereomeric state which is just as important to address. More specifically, that software has invariably failed to recognize that each of the multiple protomeric states of a compound can also exist in multiple stereomeric states: i.e., as a much larger number of “proto-stereomers.”

### SUMMARY OF THE INVENTION

Embodiments of the present invention provide a system and method for identifying structures of chemical compounds that eliminate, or at least substantially reduce, the shortcomings of prior art methods. More particularly, embodiments of the present invention include systems and methods that can identify and enumerate both protomeric and stereomeric states for compounds from a given input structure.

The following terminology is defined for purposes of this application: “stereo centers” include chiral atoms and chiral bonds; “stereomers” refer to different stereochemical isomers; “proto-centers” refer to atoms that can undergo protonation/deprotonation (e.g., acidic/basic atoms) and atoms that can undergo tautomeric transforms (e.g., proton-donors or and proton-acceptors); “protomers” are different protonation states and/or tautomeric states of a given compound; “protomeric state” refers to both the protonation state and tautomeric state of a given protomer; “protomeric transform” refers to the transformation from protomeric stateᵢ to protomeric stateⱼ, where stateᵢ and stateⱼ are different protomeric states; “proto-stereomers” are different protomers of a given compound which differ only with respect to chiralities of invertible or proto-invertible (pseudo-chiral) centers; “proto-stereo-conformers” refer to different 3D conformations of the proto-stereomers of a given compound; “invertible centers” are Sp³-hybridized atoms (typically, nitrogens) with one lone-pair of electrons and three different bonded atoms; “proto-invertible (pseudo-chiral) centers” are atoms or bonds which can switch from one chiral state (e.g., an atom which can switch from R to S or a bond which can switch from E to Z) as a result of a reversible tautomeric transformation. Furthermore, it should be understood that an acidic atom, when neutral, has a hydrogen attached and can undergo deprotonation (give off a hydrogen/proton) to become negative. A basic atom, when neutral, can undergo protonation (accept a hydrogen/proton) to become positive. A tautomeric proton-donor can donate a hydrogen/proton to an atom that acts as a tautomeric proton-accepter. Following the transfer of the proton (hydrogen atom), the former proton-donor becomes a proton-acceptor and the former proton-acceptor becomes a proton-donor. Additionally, the term “in silico” is used to refer operations or representations in a computer environment. For example, an in silico tautomeric transform refers to a virtual or computer based tautomeric transform that is performed on data representing a structure, as opposed to a tautomeric transform that occurs to the actual compound in a natural environment. “Structural information” includes any information describing a structure, such as information in connection tables or other representations of a compound structure.

Embodiments of the invention comprise using two components in tandem to address the problem of the previous structure identification programs. In one embodiment, following two preliminary (“set up”) steps, the invention includes performing the following major tasks: (a) identifying all possible protomeric states of a compound (i.e., all protonation states, all tautomeric states, and all combinations of those states), (b) identifying all invertible and “proto-invertible” chiral centers of a compound, and (c) forming all possible “proto-stereomers” of a compound (i.e., all stereomers of each and every protomer).

One embodiment of the invention uses a “Component-P” to accomplish the two preliminary steps plus tasks (a) and (b) above. This embodiment of the invention can use a “Component-S” to accomplish task (c) above. One unique aspect of the invention is the coupled, sequential use of a Component-P-like algorithm and a Component-S-like algorithm to accomplish task (c) above. This unique aspect is enabled by a unique feature of Component-P which is identified above as task (b): identification of the invertible and proto-invertible chiral centers during the process of generating all protomeric forms of a compound. The methodologies described herein can be accomplished, in one embodiment, as software code and/or firmware and/or some combination stored on a tangible media and executable by a computer system, including a microprocessor.

Another embodiment of the present invention can include a method for identifying structures of a chemical compound that comprises identifying proto-centers of a structure from a representation of the structure that contains structural information for the structure, identifying a set of protomers (e.g., a set of plausible protomers or other set of protomers) for further processing, enumerating structural information for each protomer from set of protomers for further processing, identifying any invertible and proto-invertible centers for each protomer from the structural information associated with each protomer and enumerating one or more stereomers for each protomer identified for further processing based on the identified invertible and proto-invertible centers.

Another embodiment of the present invention can include a computer program product for identifying structures of a chemical compound that comprises a computer readable medium storing a set of computer instructions, wherein the set of computer instructions comprise instructions executable to, identify proto-centers of a structure from a representation of the structure that contains structural information for the structure, identify a set of protomers for further processing, enumerate structural information for each protomer from set of protomers for further processing, identify any invertible and proto-invertible centers for each protomer from structural information associated with each protomer and enumerate one or more proto-stereomers for each protomer identified for further processing based on the identified invertible and proto-invertible centers.

Yet another embodiment of the present invention can include a method of identifying structures of a chemical compound that comprises identifying a protomer for further processing based on structural information for an input structure, identifying at least one proto-invertible center for the protomer from structural information associated with the protomer and enumerating one or more proto-stereomers for the protomer based on the at least one proto-invertible center for the protomer.

Another embodiment of the present invention can include a set of computer instructions stored on a computer readable medium. The computer instructions can be executable to identify a protomer for further processing based on structural information for an input structure, identify at least one proto-invertible center for the protomer from structural information associated with the protomer, and enumerate one or more proto-stereomers for the protomer based on the at least one proto-invertible center for the protomer.

Yet another embodiment of the present invention can include a method for identifying structures of a chemical compound that comprises receiving structural information for an input structure of a chemical compound, identifying one or more acidic/basic atoms from the structural information, identifying one or more true proton-donor/proton-acceptor pairs, determining a set of plausible protomers for the chemical compound based on the acidic/basic atoms and true proton-donor/proton-acceptor pairs identified and a set of plausibility rules; enumerating structural information for the set of plausible protomers; identifying any invertible centers and proto-invertible centers for each of the set of plausible protomers and enumerating a set of proto-stereomers for each protomer of the set of plausible protomers.

Embodiments of the present invention provide an advantage over prior art systems and methods by enumerating all or a proscribed, user-specified subset of the proto-stereomeric forms of a compound.

Embodiments of the present invention provide another advantage over prior art systems and methods by improving chemical-related research for purposes including, but not limited to, pharmaceutical discovery, herbicide discovery, insecticide discovery, cosmetic chemical discovery. Chemical discovery can be improved because the present invention can provide multiple structures for a single compound to vHTS systems such that all proto-stereomeric forms (or a subset of all proto-stereomeric forms) can be docked to biological targets in computer models.

Embodiments of the present invention provide yet another advantage because the stereomeric properties of structures can be taken into consideration when using proto-stereomers for predicting molecular properties such as partition coefficients, extent of absorption, or other properties of compounds.

### BRIEF DESCRIPTION OF THE DRAWINGS

A more complete understanding of the present invention and the advantages thereof may be acquired by referring to the following description, taken in conjunction with the accompanying drawings in which like reference numbers indicate like features and wherein:

FIG. 1 is a diagrammatic representation of one embodiment of a computer program (e.g., software) system for determining structures corresponding to a compound;

FIG. 2 is a diagrammatic representation of another embodiment of a computer program system for determining structures corresponding to a compound;

FIG. 3 is a flow chart illustrating one embodiment of method for determining structures corresponding to a compound;

FIG. 4 is a diagrammatic representation of a protomeric transform and how such a transform could affect prediction of ligand-receptor interaction;

FIG. 5 is a diagrammatic representation of a tautomeric transform and how such a transform could affect prediction of ligand-receptor interaction;

FIG. 6 illustrates one embodiment of the application of heuristics in selecting protomers for further processing, according to one embodiment of the present invention;

FIG. 7 is a diagrammatic representation illustrating invertible and proto-invertible chiral atoms;

FIG. 8 is a diagrammatic representation illustrating proto-invertible atoms and bonds;

FIG. 9 is a diagrammatic representation of one embodiment of a computer system; and

FIG. 10 is a diagrammatic representation of one embodiment of a software architecture according to one embodiment of the present invention.

### DETAILED DESCRIPTION

Preferred embodiments of the invention are illustrated in the FIGURES, like numerals being used to refer to like and corresponding parts of the various drawings.

Embodiments of the present invention provide a system and method for determining the structures of a chemical compound. Generally, embodiments of the present invention can provide a computer executable program that, for a given compound, can derive any number of additional structures for the compound from an input structure. The additional structures can include all proto-stereomers, or any subset thereof, of the compound (i.e., all stereomers for a set of protomers). The proto-stereomers can be determined based on all the protomers for the compound, a plausible set of protomers or any subset of the protomers for the compound.

As described above, the following terminology is used for purposes of this application: “stereo centers” include chiral atoms and chiral bonds; “stereomers” refer to different stereochemical isomers; “proto-centers” refer to atoms that can undergo protonation/deprotonation (e.g., acidic/basic atoms) and atoms that can undergo tautomeric transforms (e.g., proton-donors or and proton-acceptors); “protomers” are different protonation states and/or tautomeric states of a given compound; “protomeric state” refers to both the protonation state and tautomeric state of a given protomer; “protomeric transform” refers to the transformation from protomeric stateᵢ to protomeric stateⱼ, where stateᵢ and stateⱼ are different protomeric states; “proto-stereomers” are different protomers of a given compound which differ only with respect to chiralities of invertible or proto-invertible (pseudo-chiral) centers; “proto-stereo-conformers” refer to different 3D conformations of the proto-stereomers of a given compound; “invertible centers” are sp³-hybridized atoms (typically, nitrogens) with one lone-pair of electrons and three different bonded atoms; “proto-invertible (pseudo-chiral) centers” are atoms or bonds which can switch from one chiral state (e.g., an atom which can switch from R to S or a bond which can switch from E to Z) as a result of a reversible tautomeric transformation. Furthermore, it should be understood that an acidic atom, when neutral, has a hydrogen attached and can undergo deprotonation (give off a hydrogen/proton) to become negative. A basic atom, when neutral, can undergo protonation (accept a hydrogen/proton) to become positive. A tautomeric proton-donor can donate a hydrogen/proton to an atom that acts as a tautomeric proton-accepter. Following the transfer of the proton (hydrogen atom), the former proton-donor becomes a proton-acceptor and the former proton-acceptor becomes a proton-donor. Additionally, the term “in silico” is used to refer operations or representations in a computer environment. For example, an in silico tautomeric transform refers to a virtual or computer based tautomeric transform that is performed on data representing a structure, as opposed to a tautomeric transform that occurs to the actual compound in a natural environment. “Structural information” includes any information describing a structure, such as information in connection tables or other representations of a compound structure.

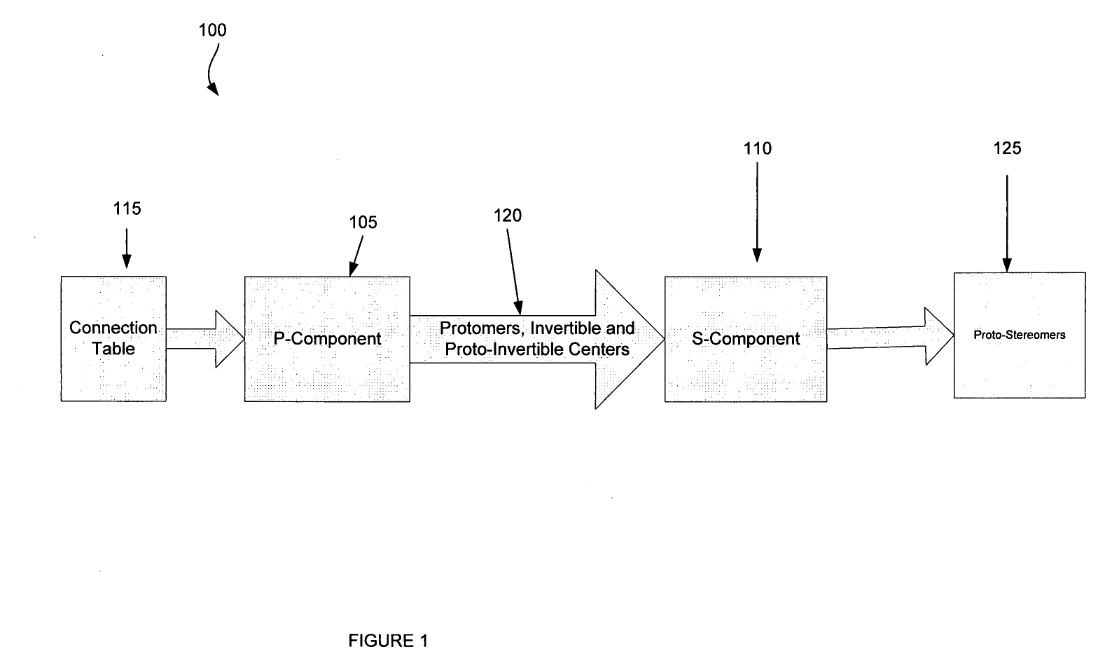

FIG. 1 is a diagrammatic representation of one embodiment of a computer program (e.g., software) system 100 for determining structures corresponding to a compound. In the embodiment of system 100, two components, P-component 105 for performing functions related to proto-centers, and S-component 110, for performing functions related to stereo-centers, act in tandem to generate a set of proto-stereomers for a compound.

In operation, P-component 105 can receive as an input a representation of a compound structure that includes structural information for the compound. The input can be loaded from memory (e.g., a database or a file), can be provided by a human user through a programmatic interface, received via a network (e.g., from another application or distributed storage) or otherwise provided to P-component 105. According to one embodiment of the present invention, the representation of the compound structure can take the form of an industry standard connection table 115. Connection table 115, as would be understood by those in the art, enumerates the atoms and bonds for a particular structure of a compound. According to other embodiments of the present invention, the compound structure can be represented in other manners, such as through connection tables according to proprietary or arbitrary formats, graphical representation in a graphical user interface or other input mechanism.

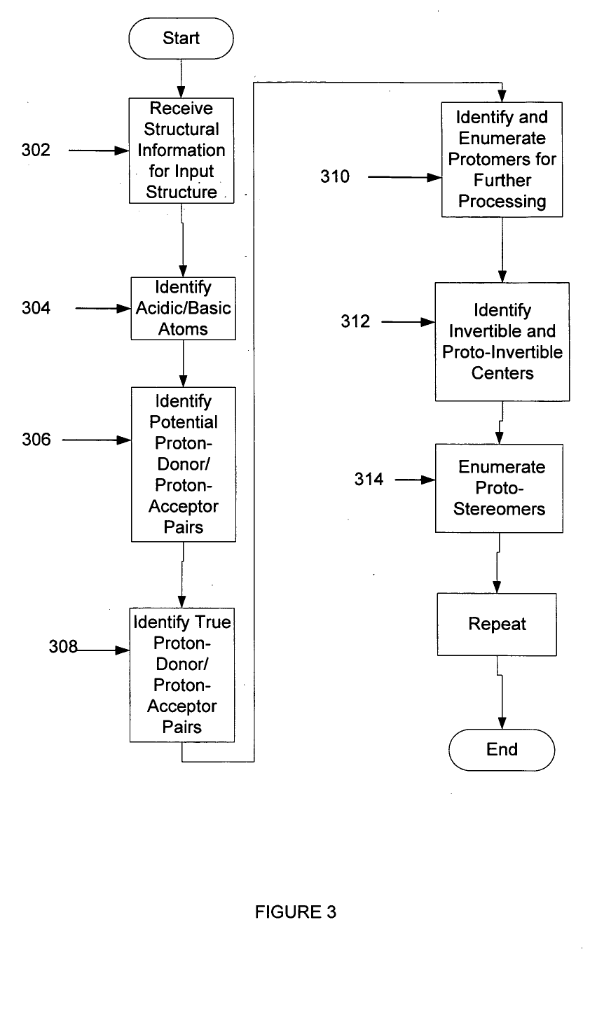

P-component 105 can identify, in silico, the possible protomeric states of the compound, including the protonation states, tautomeric states and combinations of those states. In other words, P-component 105 can determine the protomers of a compound from a given input structure. While a compound may theoretically have a great number of protomeric states (i.e., there may be a great many protomers for the compound), some number of the protomeric states may be implausible in nature. Accordingly, P-component 105 can apply plausibility rules to identify the plausible protomeric states so that only the plausible protomeric states are further processed. This can reduce processing time as implausible protomers do not have to be further processed. According to other embodiments of the present invention P-component 105 can further process all the protomers, or some arbitrary subset of the protomers for the compound (e.g., the first hundred generated). For each protomer identified for further processing (e.g., all the protomeric states, the plausible protomeric states, or some subset of all the protomeric states), P-component 105 can identify the invertible and “proto-invertible” chiral centers (i.e., atoms and/or bonds which become chiral or become achiral as the result of protomeric transforms). The identification of protomeric states and proto-invertible chiral centers is described in greater detail in conjunction with FIGS. 3 and 7-8.

S-component 110 can receive an enumeration of the protomers and proto-invertible chiral centers from P-component 105 (represented at 120) and identify the stereomers (i.e., stereo-isomers) of each protomer received from P-component 105 based on the list of proto-invertible chiral centers for the given protomer. Each stereo-isomer of a given protomer is referred to as “proto-stereomer”. In other words, proto-stereomers are different protomers of a given compound which differ only with respect to chiralities of invertible or proto-invertible (pseudo-chiral) centers According to one embodiment, a user can control how many enumerated proto-invertible chiral centers should be considered and the priority with which they are considered in generating the proto-stereomers. A representation of the proto-stereomers can be output, for example, as one or more connection tables 125. According to another embodiment of the present invention, proto-stereomers can be output in canonical structural representation as described in U.S. Provisional Patent Application No.60/524,138, entitled “System and Method for Providing Canonically Unique Structural Representation of Chemical Compounds,” by Robert S. Pearlman and U.S. patent application Ser. No., filed ______ entitled “System and Method For Providing a Canonical Structural Representation of Chemical Compounds,” by Pearlman, both of which are hereby fully incorporated by reference herein. Identification and enumeration of proto-stereomers is discussed in greater detail in conjunction with FIG. 3.

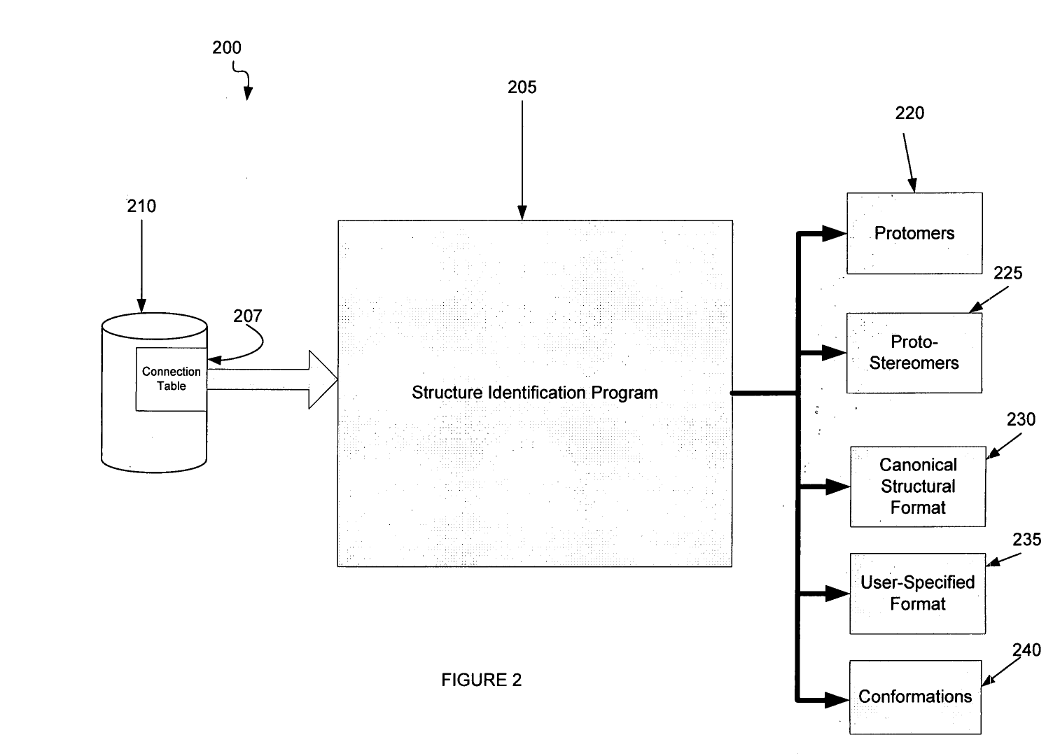

FIG. 2 is a diagrammatic representation of another embodiment of a computer program system 200 for determining structures corresponding to a compound. In system 200, a computer program 205 can be executable to receive a representation of a compound structure as, for example, a connection table 207. The input can be loaded from a memory (e.g., from database 210), provided by a human user through a programmatic interface, received via a network (e.g., from another application or distributed storage) or otherwise provided. According to one embodiment of the present invention, computer program 205 can be accessible via an application program interface (“API”), such as a SOAP API. Computer program 205 can be made available to other applications as, for example, a web service, callable function or according to other programming mechanisms known in the art.

From the input representation of a compound structure, program 205 can generate the protomers for the compound and proto-stereomers for the compound. In other words, in the embodiment of FIG. 2, the functionalities of the P-component and S-component of FIG. 1 are combined in a single component. The protomers and proto-stereomers can be output, for example, in the form of connection tables saved in a database (e.g., connection tables 220 and 225). Program 205 can also generate outputs in the form of canonical structural representation 230 or a user specified representation 235. Additionally, program 205 can output conformations 240 for each proto-stereomer.

The embodiments provided in FIG. 1 and FIG. 2 are provided by way of example, but not limitation. As would be understood to those of ordinary skill in the art, embodiments of the present invention can be implemented as a set of computer executable instructions (software, firmware, or some combination thereof) stored on a tangible medium (RAM, ROM, EEPROM, Flash memory, optical storage, magnetic storage or other storage medium known in the art). The instructions can be accessible by the processor via a bus and memory controllers, over a network or in any other manner known in the art. The computer instructions can be implemented as a standalone program, multiple programs, modules of another program, callable functions or according to any suitable programming scheme and can be written in any suitable programming language such as C++ or other programming language.

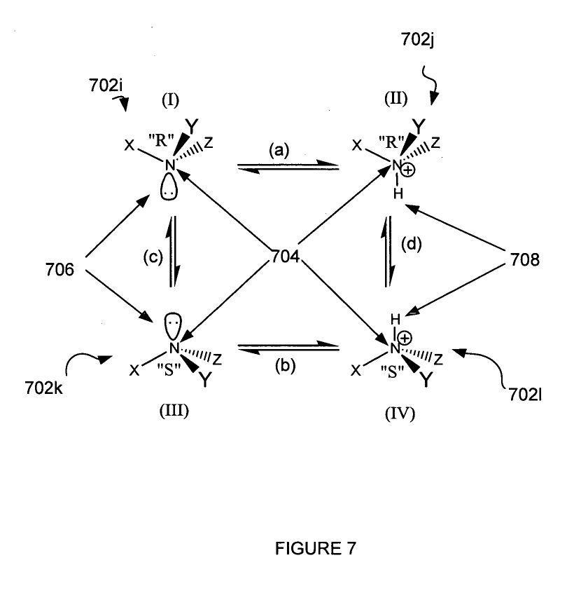

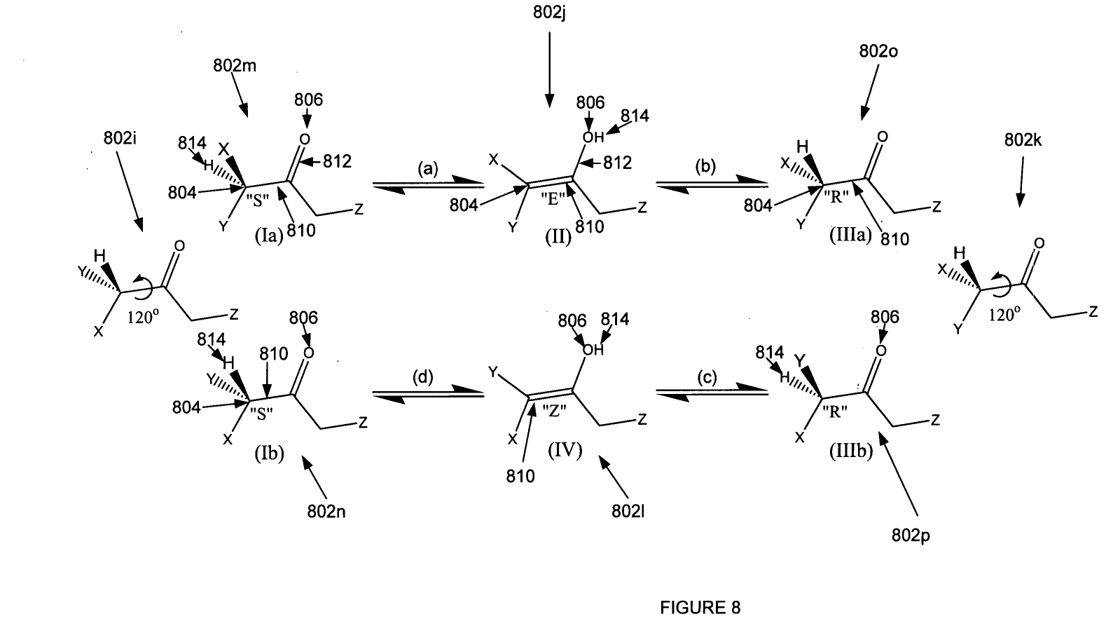

FIG. 3 is a flow chart illustrating one embodiment of a method for determining structures for a compound. The methodology of FIG. 3 can be implemented through execution of one or more sets of computer instructions (e.g., software programs, firmware, and/or hardware) stored on a computer readable medium. At step 302, structural information is extracted from an input structure. Typically, structural information for an input structure is provided in a connection table, though it should be understood that the initial compound structure can be input according to other mechanisms. Connection tables usually provide an atom number, from 1 to the highest number of atoms in the compound, the atomic number for each atom, the other atoms in the compound to which a particular atom is bonded, and the bond type of each bond. The connection table thus provides an in silico representation of a compound, including an ordered list of atoms and bonds, including the type of bond and atoms connected by the bonds for the input structure. From the connection table, the atoms, bonds and atom-centered and bond-centered chiralities of truly chiral atoms and bonds (as opposed to the chiralities of proto-invertible chiral centers, described below in conjunction with FIGS. 7-8) can be determined.

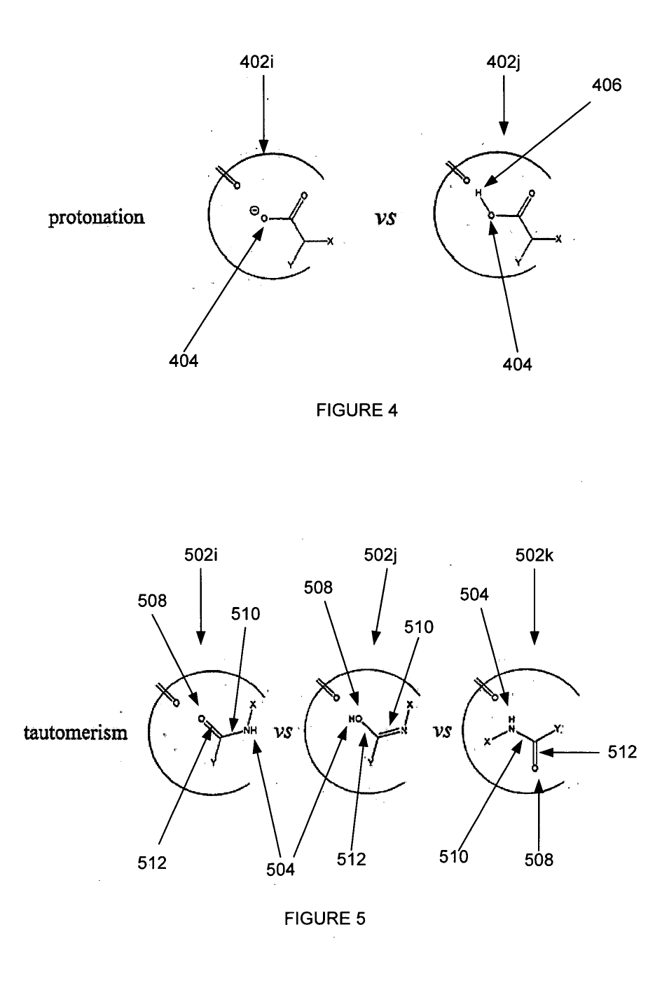

At steps 304, 306 and 308 proto-centers can be identified from the structural information of the input structure. There are two types of proto-centers, atoms which undergo protonation/deprotonation and atoms which undergo tautomeric transforms. Deprotonation means the removal of a proton (hydrogen ion) from an atom which, prior to removal, was classified as an “acidic atom”. Following deprotonation, such atom is then classified as a “basic atom”. Protonation means the addition of a proton to an atom which, prior to the addition, was classified as a basic atom. Following protonation, the atom is classified as acidic. Protonation and deprotonation transforms increase and degrease the total number of protons in a molecular structure, respectively. FIG. 4 provides a diagrammatic representation of protonation. In step 304, atoms which undergo protonation/deprotonation can be identified by, for example, comparing the atoms in the connection table to a list of atoms that undergo protonation/deprotonation.

Atoms which can undergo tautomeric transforms can also be identified (step 306 and step 308). In contrast with protonation/deprotonation transforms, tautomeric transforms do not change the number of protons in the molecular structure. Rather, tautomeric transforms involve moving a proton from one atom, called a proton-donor, to another atom, called a proton-acceptor. Proton-donors include, but are not limited to, atoms previously described as acidic and proton-acceptors include, but are not limit to, atoms previously described as basic. At step 306, potential proton-donors and proton accepters in a given structure can be identified. This can be done, for example, by comparing the atoms enumerated in the connection table with a predefined list of possible proton-donor and proton-acceptors

When potential proton-donors and proton-acceptors have been identified based, for example, on a list of proton-donor and proton-acceptor possibilities, true proton-donors and proton-acceptors can be identified based on conjugated paths (step 308) found from the connection table (or other in silico representation of the input structure). For a potential proton-donor to be classified as a true proton-donor it must be connected to a potential proton-acceptor by one or more conjugated paths and for a potential proton-acceptor to be classified as a true proton-acceptor it must be connected to a potential proton-donor by one or more conjugate paths. It should be noted that the term “conjugated path” is well known in the art and is defined as a series of bonds that enable facile movement of a π-electron from one end of the path to the other. Conjugated paths are made up of alternating signal and double bonds. As shown in FIG. 5, discussed below, tautomeric transform not only move a proton from a proton-donor to a proton-acceptor, but also change the bond-types of the bonds within the associated conjugated path (i.e., change single bonds to double bonds, and double bonds to single bonds). Once a tautomeric transformation is complete, the former proton-donor becomes a proton-acceptor. According to one embodiment of the present invention, the connection table can be analyzed to determine if conjugated paths exist between the potential proton-donors and potential proton-acceptors identified in step 306 to eliminate proton-donors and proton-acceptors which can not possibly participate in protomeric transforms. Additional analysis, as would be understood by those skilled in the art, can then be used to derive the true proton-acceptors and true proton-donors. The additional analysis can include, for example, the application of rules that define true proton-acceptors and true proton-donors.

Based on the proto-centers identified in steps 304, 306 and 308, a set of protomers (i.e., structures with a particular protomeric state) can be identified and enumerated for further processing (step 310). The protomers identified for further processing can include protomers with all possible protomeric states that can be formed from the input structure, a set of plausible protomeric states that can be formed from the input structure or an arbitrarily defined set of protomeric states that can be formed from the input structure. In general, protomers can be identified by analysis of the acidic and basic atoms identified at step 304, the true proton-donors and proton-acceptors identified at step 308 and the possible paths connecting each proton-donor/proton-acceptor pair.

Each atom that can undergo protonation/deprotonation (e.g., for each atom acid/base atom identified in step 304), can result in two possible protomers. If a compound contained three atoms that could undergo protonation/deprotonation and not accounting for tautomeric transforms, there would be a total of 2³ acidic/basic possibilities. There would be eight possible protomeric states for the compound without considering tautomeric transforms. Similarly, if there were four proton-donor/proton-acceptor pairs, each connected by a single conjugated path, and each path independent of the other paths, there would be 2⁴ or 16 tautomeric possibilities. If the acidic/basic atoms are not amongst the proton-donors/proton-acceptors, then, by combining the acid/base possibilities and tautomeric possibilities, there would be 16×8, or 128 protomeric states.

According to one embodiment of the present invention, if an atom is identified as acidic or basic for a protomeric transform, that atom is not simultaneously available for participation in tautomeric transforms. Assume for example, an atom can both undergo protonation and is a proton-acceptor. In generating one protomer, protonation, but not the tautomeric transform, is applied to the atom. In generating another protomer, the tautomeric transform, rather than protonation, is applied to that atom. Protonation and the tautomeric transform would not both be applied in generating a protomer, however, as the atom would either gain a proton through protonation or the tautomeric transform, but not both at the same time. Moreover, if a given proton-donor/proton-acceptor pair is connected by multiple conjugated paths, there can be additional protomers. For example, if a proton-donor/acceptor pair is connected by three different conjugated paths (as is possible when one or both atoms is/are contained in cyclic substructures) then the number of tautomeric possibilities for that single pair would be six rather than two. Just as specification of acidic/basic atoms limits tautomeric possibilities, specification of one conjugated path limits the possibilities for any other conjugated path which has one or more bonds in common with the first.

Embodiments of the present invention can, thus, identify the protomers for a given input structure by performing in silico protonation/deprotonation transforms on acidic/basic atoms identified from the connection table and in silico tautomeric transforms between true proton-acceptor/proton-donor pairs along conjugated paths identified from the connection table. The in silico tautomeric transforms can be performed heuristically such that the in silico tautomeric transforms can be performed on an in silico structure generated from a previous in silico tautomeric transform of the input structure. There are a variety of methods known in the art to determine the various tautomeric possibilities for an input structure. Tautomeric enumeration, for example, uses a topological approach that performs all the possible in silico tautomeric transforms available for an input structure. However, this can result in a great number of tautomeric possibilities, many which may not exist in nature. If all the possible tautomeric transforms are performed between apparent proton-donor/proton-acceptor pairs on: Nc1nc2nc(N)nc3nc(Nc4nc5nc(N)nc6nc(Nc7nc8nc(N)nc9nc(N)nc(n7)n98)nc(n4)n56)nc(n1)n23, there are approximately 55,251 tautomers (e.g., tautomeric possibilities). Empirical research has, however, shown that there may only be one tautomer of this compound that appears in the real world. Therefore, using tautomeric enumeration may lead to a great number of tautomers that are not plausible in nature.

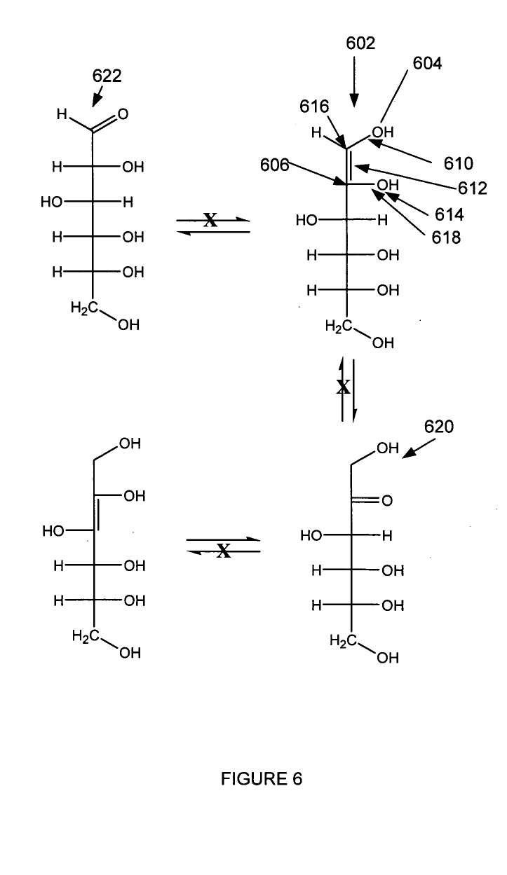

According to one embodiment of the present invention, rules can be applied to reduce the number of protomers selected for further processing. The rules can be applied such that plausible protomers are enumerated for further processing. Rules for generating an arbitrary set of plausible protomers will be referred to, for the sake of simplicity, as “plausibility rules”. Plausibility rules can be applied in a variety of manners including heuristically. Plausibility rules can be provided such that certain protomeric transforms are not applied in silico, or can be applied to the results of in silico transforms to eliminate particular protomers. For example, one plausibility rule may dictate that a particular in silico tautomeric transform should not be performed in the first place while another plausibility rule can be applied to determine if a protomer created by a particular in silico transform should be selected for further processing based on predefined criteria. As an example, in determining protomeric states for an input structure, embodiments of the present invention may, for example, apply enol→keto transforms but not perform keto→enol transforms. This rule models the fact that keto states are usually lower in energy than enol states, so it is less plausible for a keto→enol transform to occur in nature. Moreover, formation of enol can lead to scrambled chiralities in carbohydrates, peptides and other compounds. However, exceptions to this rule can exist. A keto→enol transform may be applied for activated methylenes with a second electron withdrawing group, 1,2-dione systems, or to transform cyclohexadiene-one to phenol. In the example of cyclohexadiene-one to phenol, applying a keto→enol transform models the fact that compounds in nature will generally take more aromatically stable state. Thus, for example, keto tautomers of phenols will not be identified for further processing, but keto tautomers of most hydroxy furans and pyrroles will be identified. The application of an example keto to/from enol transform rules are illustrated in greater detail in conjunction with FIG. 6.

Other rules can include, for example, that in silico tautomeric transforms that disrupt aromaticity will not be performed. Using the example above of Nc1nc2nc(N)nc3nc(Nc4nc5nc(N)nc6nc(Nc7nc8nc(N)nc9nc(N)nc(n7)n98)nc(n4)n56)nc(n1)n23, only one tautomer is identified for further processing if tautomeric transforms that disrupt aromaticity are not performed. For some compounds, however, tautomeric transforms that disrupt aromaticity may be performed because of other factors. For example, the keto form of some hydroxyl furans and pyrroles may be selected for further processing as the amide and ester resonance stabilizes the keto form of those hydroxy furans and pyrroles. As another example, a plausibility rule can dictate that protomers that fall outside a particular energy window (e.g., a user-specified energy window) are not selected for further processing. This is similar to the energy window concept used when considering conformers, but is based on the energy of a protomer rather than the energy of a conform. The plausibility rules provided above are provided by way of example, but not limitation. Other known plausibility rules can be implemented as well as plausibility rules that are developed to determine which protomers are more or less plausible in nature.

The set of protomers identified for further processing can include all possible protomers based on an input structure, a set of plausible protomers as defined by plausibility rules or other mechanism, or an arbitrarily selected set of protomers based on user specifications (e.g., only up to the first hundred protomers will be selected for further processing), processing limitations or other criteria. The protomers selected for further processing can be enumerated, for example, through enumerating connection tables or other in silico representation for providing structural information of each selected protomer.

At step 312, invertible and proto-invertible centers can be identified for each protomer identified in step 310 based on the structural information associated with each such protomer. Invertible atoms are described in greater detail below in conjunction with FIG. 7. The proto-invertible centers identified can include proto-invertible chiral atoms and proto-invertible chiral bonds. Identification of proto-invertible chiral atoms can be based on the application of one or more rules that define which atoms are proto-invertible given the structural information of each protomer. Generally, a chiral atom is an atom which has non-superimposable mirror image. For example, an atom with four non-equivalent atoms bonded to it in tetrahedral fashion is chiral. Inversion of the tetrahedron results in a structure which is the non-superimposable mirror image of the original. The two mirror images are typically designated as R and S. For some chiral atoms, protomeric transform followed by the reverse of that transform (or other tautomeric transform involving the same atom) can invert the chirality of such atoms. This is due to the fact that protons can be added to basic atoms or proton-acceptor atoms from either side, thereby creating either R or S chiralities. Such atoms are referred to as being proto-invertible chiral centers. Invertible and proto-invertible chiral atoms are described in greater detail below in conjunction with FIG. 7.

With respect to proto-invertible chiral bonds, a chiral bond is a double bond between two atoms of which neither is bonded to two equivalent atoms. Reversal of positions of the two atoms attached to one of the double-bonded atoms yields a different, non-superimposable stereomer. Such stereomers are traditionally designated Entgegen (“E”) or Zusammen (“Z”). As described earlier, conjugated paths consist of altering single and double bonds. Tautomeric transforms result in conversion of those double bonds to single bonds and vice versa. Unlike double bonds, single bonds are rotatable. After such a rotation is followed by another tautomeric transform which converts the single bond back to a double bond, the bond-centered chirality (i.e., E versus Z) is reversed. This is illustrated in FIG. 8, discussed below. Such bonds are referred to as proto-invertible chiral bonds.

At step 314, the stereomers (stereo-isomers) for each protomer identified in step 310 can be enumerated based on the proto-invertible centers identified for each of those protomers in step 312. For each protomer, there are two possible states for each invertible and proto-invertible chiral center: R or S for invertible and proto-invertible chiral atoms and E or Z for proto-invertible chiral bonds. If there are, for example, two proto-invertible chiral atoms and three proto-invertible chiral bonds for a protomers, there are 2⁽²⁺³⁾ or 32 stereomers for the given protomer. Each protomer of compound may have a different number proto-invertible centers and therefore a different number of stereomers. The stereomers of the protomers are referred to as the proto-stereomers. The proto-stereomers of a protomer can be identified in silico by, for example, enumerating each possible state for the protomer's proto-invertible centers. The proto-steromers can be represented in silico as one or more connection tables, according to a canonically unique structural representation, according to user-defined format or in any other manner suitable for representing chemical structures.

Embodiments of the present invention can thus identify from a representation of a structure (e.g., a connection table) atoms that undergo protonation/deprotonation and tautomeric transforms (i.e., can identify proto-centers). Protonation and tautomeric transforms can be applied, in silico, based on the structural information to identify protomers for further processing. The protomers identified for further processing can include all possible protomers identified from the structural information, a plausible set of protomers identified based on plausibility rules or by some other mechanism, or as an arbitrarily defined subset of the possible protomers. The protomers identified for further processing can be enumerated in silico through connection tables or other mechanism for representing structures in a computer program environment. From the structural information for each protomer identified for further processing, embodiments of the present invention can identify proto-invertible centers (e.g., proto-invertible chiral atoms and proto-invertible chiral bonds). The proto-stereomers can then be enumerated for each protomer through enumeration of the protomer having the proto-invertible centers in all possible states. The structural information for each proto-stereomer can be formatted as a connection table, according to a canonical format or according to other suitable mechanism. The methodology of FIG. 3 can be repeated as needed or desired.

FIG. 4 is a diagrammatic representation of protonation in the context of ligand-receptor interaction. In FIG. 4, a compound in stateᵢ (identified at 402ᵢ) undergoes a protomeric transform (e.g., protonation) to stateⱼ (identified at 402ⱼ). The compound at 402ᵢ includes an oxygen atom 404 that is negative. During protonation, a hydrogen ion 406 bonds with oxygen 404 to form an acidic compound at 402ⱼ. Both 402ᵢ and 402ⱼ represent different protomers of the same compound. 402ⱼ can interact (dock) favorably with the receptor whereas 402ᵢ can not.

FIG. 5 is a diagrammatic representation of tautomerism. In the example of FIG. 5, the compound has at least three tautomeric and docking possibilities, represented at 502ᵢ, 502ⱼ and 502ₖ, 502ⱼ and 502ₖ represent favorable docking possibilities whereas 502ᵢ is an unfavorable possibility. In state 502ᵢ, a hydrogen ion 504 is bonded to a nitrogen atom 506. Nitrogen atom 506 is separated from oxygen 508 via a conjugated path made up of single bond 510 between nitrogen atom 506 and a carbon atom (shown as the junction of bonds 510 and 512) and a double bond 512 between the carbon atom and oxygen 508. In a tautomeric transform, hydrogen ion 504 can move along the conjugated path to bond with oxygen atom 508. In this case, nitrogen atom 506 acts as a proton-donor and oxygen atom 508 acts as a proton-acceptor. Note that at 502ⱼ, bond 510 is now a double bond and bond 512 is now a single bond. Hydrogen ion 504 can move back to oxygen atom 508 along the conjugated path formed by bond 510 and 512 to result in 502ₖ.

Atoms that can undergo protonation/deprotonation, such as illustrated in FIG. 4, can be identified from a connection table based on knowledge of atoms that can undergo protonation/deprotonation. Proton-donor/proton-acceptor pairs can be identified from a connection table by identifying atoms that are known to act as proton-donors/proton-acceptors and then determine, from the connection table, if those atoms are separated by a conjugated path. By identifying atoms that can undergo protonation/deprotonation and true proton-donor/proton-acceptor pairs, the proto-centers for a given structure can be identified.

FIG. 6 illustrates one embodiment of the application of heuristics (plausibility rules) in selecting protomers for further processing. Assume, for example, that structure 602 is provided as an input structure (e.g., the structural information for structure 602 is provided by way of a connection table). Embodiments of the present invention can identify the various true proton-donor/proton-acceptor pairs, as discussed above based on atoms known to be proton-donors/proton-acceptors and conjugated paths. For example, oxygen atom 604 and carbon atom 606 (carbon atoms are generally represented in the art as a junction of bonds) can be identified as a true proton-donor/proton-acceptor pair based on the fact that oxygen atom 604 can shed hydrogen ion 608 and is separated from carbon atom 606 by a single bond 610 and a double bond 612. Similarly, oxygen atom 614 and carbon 616 are a true-proton-donor/proton-acceptor pair separated by single bond 618 and double bond 612. Embodiments of the present invention can perform in silico enol→keto transforms to transform structure 602 to identify structure 620 and structure 622. These structures could then be enumerated by, for example, connection tables that show the changes in hydrogen ions and bonds. If, on the other hand, structure 622 is provided as the input structure (i.e., if structural information for structure 622 is provided), embodiments of the present invention would not, according to a plausibility rule, perform an in silico keto→enol transform to identify structure 602.

A plausibility rule such as this can be in place to model the fact that the keto form is usually lower in energy than the enol form and, therefore, it is less likely that the compound will take the enol form in nature. However, exceptions to such a rule can also be implemented. Examples of other rules include rules based on aromaticity (e.g., tautomeric forms that disrupt aromatic stability will not be selected for further processing) or energy windows (e.g., only protomers within a particular energy window will be selected for further processing). The examples of plausibility rules above are provided by way of example, but not limitation. The plausibility rules can be arbitrarily complex and new rules can be implemented as they are developed.

FIG. 7 is a diagrammatic representation providing an example of invertible and proto-invertible chiral atoms. In the example of FIG. 7, a compound structure can have four states represented as 702ᵢ, 702j, 702ₖ and 702ₗ. For each state, the chirality, i R or S, is also indicated. At states 702ᵢ and 702ₖ, nitrogen atom 704 is basic (i.e., can receive a hydrogen ion/undergo protonation) and has a lone pair of electrons 706. Transform (c) inverts the lone pair of electrons between states 702ᵢ and 702ₖ, which can cause the remaining atoms bonded to nitrogen atom 704 to shift. In this case, no bonds need to be broken. Inversion, such as shown by transform (c) can occur trillions of times a second in nature. Nitrogen atom 704 is “invertible.” Because nitrogen atom 704 has a pair of free electrons in states 702ᵢ and 702ₖ, a hydrogen atom 708 can bond to nitrogen atom 704. Transforms (a) and (b) of FIG. 7 are protonation transforms that add hydrogen ion 708 to transform state 702ᵢ to 702j and 702ₖ to 702ₗ, respectively. Because the nitrogen atom 708 has four other atoms attached in states 702ⱼ and 702ₖ, nitrogen atom 708 is no longer invertible. In other words, the compound can not shift from state 702ⱼ to 702ₗ (i.e., undergo transform (d)) without breaking bonds. Through protonation/deprotonation and inversion, however, the compound can shift from 702ⱼ to 702ₗ by losing a hydrogen (transform (a)), inverting (transform (c)) and gaining a hydrogen (transform (b)). Because 702ⱼ can invert to 702ₗ through protonation/deprotonation and inversion, nitrogen atom 704 at state 702ⱼ is “proto-invertible.”

For a protomer structure at 702ⱼ or 702ₗ, embodiments of the present invention can determine that nitrogen atom 704 is proto-invertible based on the fact that it has four non-equivalent atoms bonded to it in tetrahedral fashion and that it can undergo deprotonation. Identification of atoms that are proto-invertible can be based, for example, on a knowledge base of atoms and configurations for known proto-invertible chiral atoms. Thus, given the input structure for the compound at state 702ⱼ (an R state), embodiments of the present invention, by identifying nitrogen atom 708 as proto-invertible also identify the fact that there should be an S state for nitrogen atom 708. Similarly, for state 702ⱼ, if the protomer of state 702ᵢ is selected for further processing, embodiments of the present invention can identify that there should also be an S state based on the proto-invertible nitrogen atom 704.

FIG. 8 is a diagrammatic representation illustrating proto-invertible chiral atoms and chiral bonds. In the real world, structures 802ᵢ, 802ⱼ, 802ₖ and 802ₗ exist via tautomeric transforms. Structures 802ₘ and 802ₙ simply represent conformers of 802ᵢ and 802ₒ and 802ₚ represent conformers of 802ₖ. For the sake of example, at state 802ₘ, carbon atom 804 appears as a left handed (S) chiral atom. Carbon atom 804 can be identified as a proton-donor separated from proton-acceptor oxygen atom 806 by bond 810 and bond 812. Therefore, tautomeric transform (a) can occur to yield state 802ⱼ. In state 802ⱼ, oxygen atom 806 is again separated from carbon atom 804 by bond 810 and 812. Because X and Z are on opposite sides of double bond 810, it is an E bond. Hydrogen 814 can then move back to bond with carbon atom 804, either returning to state 802ᵢ or undergoing transform (b) to state 802ₒ. In state 802ₒ, carbon atom 804 has inverted to right handed chirality (R). Because bond 810 is now a single bond, rotation can occur to change from 802ₒ to 802ₚ. In this case, the structure remains the same. Tautomeric transform (c) can occur to bond hydrogen 814 with oxygen atom 806 to create Z bond 810 with atoms X and Z on the same side. If tautomeric transform (d) occurs, hydrogen 814 can return to carbon atom 804 to yield 802ₙ. Because bond 810 is now a single bond, 802ₙ can rotate back to 802ₘ without changing the structure of the compound.

In the example above, carbon atom 804 is a proto-invertible atom and bond 810 is a proto-invertible bond. Given, for example, a representation of the structure at 802ₘ, carbon atom 804 can be identified as a proto-invertible atom and bond 810 can be identified as proto-invertible bond. As with identification of proto-invertible atoms, proto-invertible bonds can be identified, for example, by comparing the structural information for a given protomer to a knowledge base of bond configuration that result in proto-invertible chiral bonds or through other mechanism of identifying proto-invertible bonds. Because the structure at 802ₘ has one proto-invertible atom and one proto-invertible bond, the present invention can determine that there are four proto-stereomers: the structures at 802ᵢ, 802ⱼ, 802ₖ and 802ₗ (recall that 802ₘ and 802ₙ are different conformers of the same structure and 802ₒ and 802ₚ are conformers of the same structure). The expected proto-stereomers, in this example, would have a structure with carbon atom 804 having S chirality (shown at 802ᵢ), carbon atom 804 having R chirality (shown at 804ₗ), bond 810 being an E bond (shown at 802ⱼ) and bond 810 being a Z bond (shown at 802ₖ).

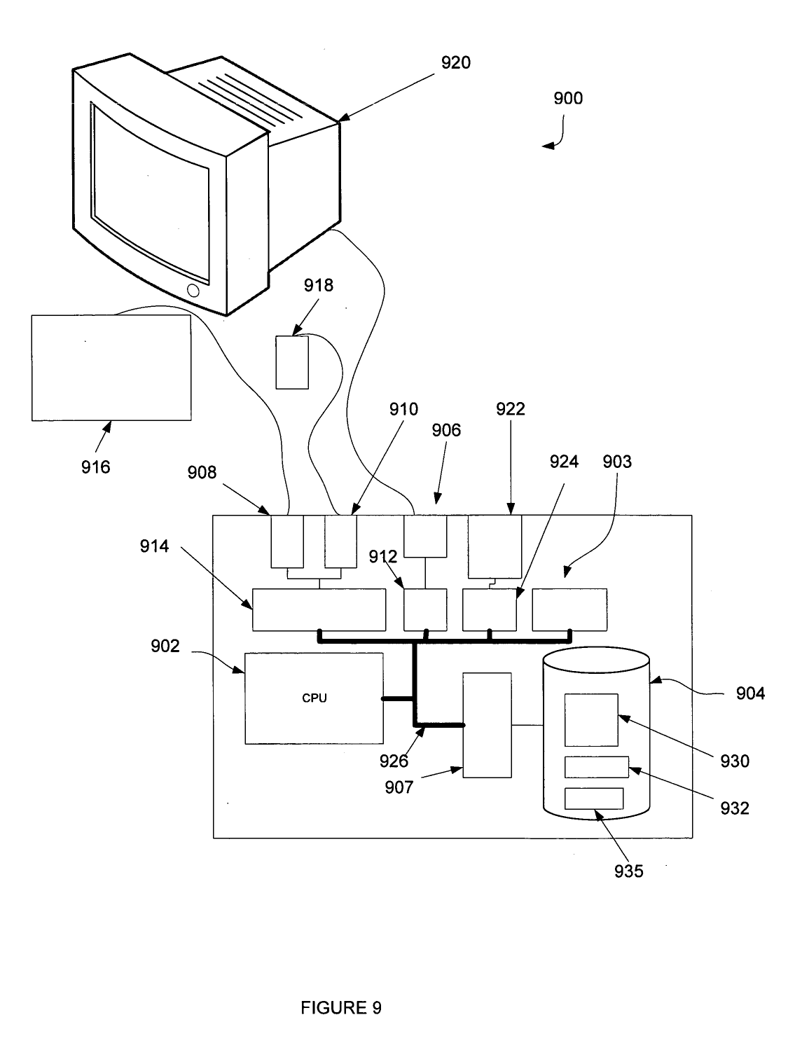

As described earlier, embodiments of the present invention can be implemented as a set of computer instructions stored on a computer readable medium (e.g., as a computer program product). FIG. 9 provides a diagrammatic representation of one embodiment of a computing device 900 that can provide a system for identifying structures of a compound. Computing device 900 can include a processor 902, such as an Intel Pentium 4 based processor (Intel and Pentium are trademarks of Intel Corporation of Santa Clara, Calif.), a primary memory 903 (e.g., RAM, ROM, Flash Memory, EEPROM or other computer readable medium known in the art) and a secondary memory 904 (e.g., a hard drive, disk drive, optical drive or other computer readable medium known in the art). A memory controller 907 can control access to secondary memory 904. Computing device 900 can include I/O interfaces, such as video interface 906 and universal serial bus (“USB”) interfaces 908 and 910 to connect to input and output devices. A video controller 912 can control interactions over the video interface 906 and a USB controller 914 can control interactions via USB interfaces 908 and 910. Computing device 900 can include a variety of input devices such as keyboard 916 and a mouse 918 and output devices such as display device 920 (e.g., a monitor). Computing device 900 can further include a network interface 922 (e.g., an Ethernet port or other network interface) and a network controller 924 to control the flow of data over network interface 922. Various components of computing device 900 can be connected by a bus 926.

Secondary memory 904 can store a variety of computer instructions that include, for example, an operating system such as a Windows operating system (Windows is a trademark of Redmond, Wash. based Microsoft Corporation) and applications that run on the operating system, along with a variety of data. More particularly, secondary memory 904 can store a software program 930 that enumerate proto-stereomers for a given input structure. During execution by processor 902, portions of program 930 can be stored in secondary memory 904 and/or primary memory 903.

In operation, program 930 can be executable by processor 902 to identify from a representation of a structure (e.g., a connection table) atoms that undergo protonation/deprotonation and tautomeric transforms (i.e., can identify proto-centers). Program 930 can perform in silico protonation/deprotonation and tautomeric transforms based on the structural information provided for the input structure. By performing the protonation/deprotonation and tautomeric transforms, program 930 can identify protomers for further processing. In identifying protomers for further processing, program 930 can apply plausibility rules (represented at 932) to limit the number of protomers selected for further processing to a plausible protomers or some arbitrary subset of possible protomers. The protomers identified for further processing can be enumerated in silico through connection tables or other mechanism for representing structures in a computer program environment. From the structural information for each protomer identified for further processing, program 930 can identify proto-invertible centers (e.g., proto-invertible chiral atoms and proto-invertible chiral bonds). Program 930, based on the proto-invertible centers identified for a protomer, can enumerate the proto-stereomers for the protomer. The structural information for each proto-stereomer (represented at 935) can be formatted as a connection table, according to a canonical format or according to other suitable mechanism.

Computing device 900 of FIG. 9 is provided by way of example only and it should be understood that embodiments of the present invention can implemented as a set of computer instructions stored on a computer readable medium in a variety of computing devices including, but not limited to, desktop computers, laptops, mobile devices, workstations and other computing devices. Program 930 can be executable to receive and store data over a network and can include instructions that are stored at a number of different locations and are executed in a distributed manner. While shown as a stand alone program in FIG. 9, it should be noted that program 930 can be a module of a larger program, can comprise separate programs operable to communicate data to each other via, for example, Unix pipes, or can be implemented according to any suitable programming scheme.

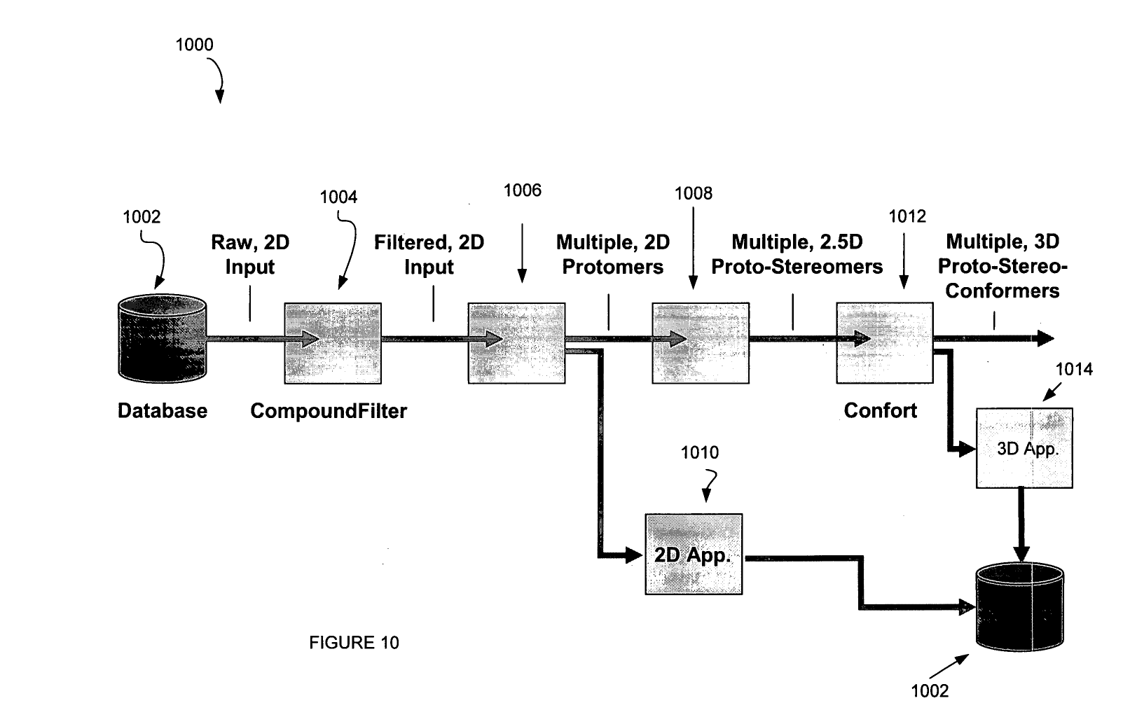

FIG. 10 is a diagrammatic representation of one embodiment of a software architecture 1000 in which embodiments of the present invention can be implemented. According to the embodiment of FIG. 10, a database 1002, file or other data storage mechanism can store two-dimensional compound information (e.g., connection tables or other representations of structures). A compound filter 1004 can load representations of structures (e.g., connection tables) and determine if further processing of a particular input structure should occur. For example, compound filter 1004 may apply predefined rules such that particular classes of compounds are not further processed in silico. Compound filter 1004 can pass the structural representations of input structures that are selected for further processing to P-component 1006.

P-component 1006 can identify, in silico, the possible protomeric states of each input compound, including the protonation states, tautomeric states and combinations of those states. In other words, P-component 1006 can determine the protomers of each compound from a given input structure. While a compound may theoretically have a great number of protomeric states (i.e., there may be a great many protomers for the compound), some number of the protomeric states may be implausible in nature. Accordingly, P-component 1006 can identify the plausible protomeric states so that only the plausible protomeric states are further processed. This can reduce processing time as implausible protomers do not have to be further processed. According to other embodiments of the present invention P-component 1006 can further process all the protomers, or some arbitrary subset of the protomers for the compound (e.g., the first hundred generated). From the protomeric states (e.g., all the protomeric states, the plausible protomeric states, or some set of the protomeric states), P-component 1006 can identify the “proto-invertible” centers of the compound (i.e., atoms and/or bonds which become chiral or become achiral as the result of protomeric transforms). P-component 1006 can pass two-dimensional representations of each protomer (e.g., in the form of connection tables or other form) and the proto-invertible centers to S-component 1008. Additionally, P-component 1006 can pass the pass two-dimensional representations of each protomer to any application that acts on two dimensional representations of compound structures (e.g., 2D application 1010). 2D application 1010 can perform various operations on the two-dimensional representations and output data to database 1002.

S-component 1008 can receive an enumeration of the protomers and indications of the invertible and proto-invertible chiral centers from P-component 1006 and can identify and enumerate the stereomers of each protomer received from P-component 1006 based on the list of invertible and proto-invertible centers for the given protomer. The proto-stereomers for a given compound represent the structures the given compound can take. According to one embodiment, a user can control how many invertible and proto-invertible centers should be considered and the priority with which they are considered in generating the proto-stereomers. S-component 1008 can pass a representation of the proto-stereomers to an application, such as the Confort application 1012, that can generate conformers of each compound for each proto-stereomer of the compound. Data, such as generated by application 1014, can be associated with the conformations and can be stored, for example, in database 1002. Structural information for the proto-stereomers can also be stored in database 1002 or can be passed to other applications for further processing.

The embodiment of FIG. 10 is provided by way of example, but not limitation. As would be understood to those of ordinary skill in the art, embodiments of the present invention can be implemented as a set of computer executable instructions (software, firmware, or some combination thereof) stored on a tangible medium (RAM, ROM, EEPROM, Flash memory, optical storage, magnetic storage or other storage medium known in the art). The instructions can be accessible by the processor via a bus and memory controllers, over a network or in any other manner known in the art. The computer instructions can be implemented as a standalone program, multiple programs, modules of another program, callable functions or according to any suitable programming scheme and can be written in any suitable programming language such as C++ or other programming language.

Embodiments of the present invention provide advantages in chemical related research by providing multiple proto-stereomers for a compound rather than a single structure. This can allow applications that rely on structural information for compounds to process additional structures for each compound. In computer aided drug discovery (“CADD”), for example, this can lead to in silico testing of a large number of structures for a single compound, whereas only one structure or a limited number of structures would have been tested in the past. By using multiple structures for the compound, a CADD program is more likely to simulate the structure of the compound that would occur in nature for a set of conditions. For example, by docking in silico all or a number proto-stereomers to biological targets, pharmaceutical and agrochemical companies are less likely to fail to consider compounds which might have been overlooked if only one proto-stereomer had been docked. By not failing to consider such compounds, scientific researchers have a better chance to discover useful compounds more quickly and at a lower cost.

Additionally, through considering computer-predicted physical and physical-chemical properties of a number of proto-stereomers for a compound, scientists will be better able to make better predictions of the true properties of that compound than if they had considered only the computer-predicted properties of a single proto-stereomer. Better predictions of such properties can greatly accelerate the discovery of chemicals for many purposes in addition to pharmaceutical, agrochemical and cosmeceutical purposes. For example, better predictions of molecular properties can not only lead to better absorption (faster action) of drugs, but can also facilitate the discovery of better flavorings, detergents, paints and other chemicals that are useful to society.

Although the present invention has been described in detail herein with reference to the illustrated embodiments, it should be understood that the description is by way of example only and is not to be construed in a limiting sense. It is to be further understood, therefore, that numerous changes in the details of the embodiment of this invention and additional embodiments of this invention will be apparent, and may be made by, persons of ordinary skill in the art having reference to this description. It is contemplated that all such changes and additional embodiments are within scope of the invention as claimed below.

1. Method for identifying structures of a chemical compound comprising:
identifying proto-centers of a structure from a representation of the structure, wherein the representation of the structure contains structural information for the structure;
identifying a set of protomers for further processing;
enumerating structural information for each protomer from the set of protomers for further processing;
identifying any invertible and proto-invertible centers for each protomer from structural information associated with each protomer; and
enumerating one or more proto-stereomers for each protomer identified for further processing based on the identified invertible and proto-invertible centers.

2. The method of claim 1, wherein identifying proto-centers further comprises identifying one or more acidic atoms.

3. The method of claim 1, wherein identifying proto-centers further comprises identifying one or more basic atoms.

4. The method of claim 1, wherein identifying proto-centers further comprises identifying one or more potential proton-donor/proton-acceptor pairs.

5. The method of claim 1, wherein identifying proto-centers further comprises identifying on ore or more true proton-donor/proton-acceptor pairs.

6. The method of claim 1, wherein identifying a set of protomers for further processing, comprises identifying one or more plausible protomers for further processing.

7. The method of claim 6, wherein identifying one or more plausible protomers for further processing comprises applying one or more plausibility rules.

8. The method of claim 1, wherein identifying proto-invertible centers further comprises identifying one or more proto-invertible chiral atoms.

9. The method of claim 1, wherein identifying proto-invertible centers further comprises identifying on or more proto-invertible chiral bonds.

10. The method of claim 1, wherein enumerating one or more proto-stereomers for each protomer further comprises, for each protomer:
enumerating the left hand state and right hand state for each proto-invertible chiral atom; and
enumerating E and Z state for each proto-invertible chiral bond.

11. A computer program product for identifying structures of a chemical compound comprising a computer readable medium storing a set of computer instructions, wherein the set of computer instructions comprise instructions executable to:
identify proto-centers of a structure from a representation of the structure, wherein the representation of the structure contains structural information for the structure;
identify a set of protomers for further processing;
enumerate structural information for each protomer from the set of protomers for further processing;
identify any invertible and proto-invertible centers for each protomer from structural information associated with each protomer;
enumerate one or more proto-stereomers for each protomer identified for further processing based on the identified invertible and proto-invertible centers.

12. The computer program product of claim 11, wherein identifying proto-centers further comprises identifying one or more acidic atoms.

13. The computer program product of claim 11, wherein identifying proto-centers further comprises identifying one or more basic atoms.

14. The computer program product of claim 11, wherein identifying proto-centers further comprises identifying one or more potential proton-donor/proton-acceptor pairs.

15. The computer program product of claim 11, wherein identifying proto-centers further comprises identifying on ore or more true proton-donor/proton-acceptor pairs.

16. The computer program product of claim 11, wherein identifying a set of protomers for further processing, comprises identifying one or more plausible protomers for further processing.

17. The computer program product of claim 16, wherein identifying one or more plausible protomers for further processing comprises applying one or more plausibility rules.

18. The computer program product of claim 11, wherein identifying proto-invertible centers further comprises identifying one or more proto-invertible chiral atoms.

19. The computer program product of claim 11, wherein identifying proto-invertible centers further comprises identifying on or more proto-invertible chiral bonds.

20. The computer program product of claim 11, wherein enumerating one or more proto-stereomers for each protomer further comprises, for each protomer:
enumerating the left hand state and right hand state for each proto-invertible chiral atom; and
enumerating E and Z state for each proto-invertible chiral bond.

21. A method of identifying structures of a chemical compound, comprising:
identifying a protomer for further processing based on structural information for an input structure;
identifying at least one invertible or proto-invertible center for the protomer from structural information associated with the protomer;
enumerating one or more stereomers for the protomer based on the at least one invertible or proto-invertible center for the protomer.

22. The method of claim 21, further comprising identifying at least one proto-center from the structural information for the input structure.

23. The method of claim 21, wherein the protomer is a plausible protomer based on one or plausibility rules.

24. The method of claim 21, wherein identifying the at least one invertible or proto-invertible center for the protomer comprises identifying an invertible or proto-invertible chiral atom.

25. The method of claim 24, wherein enumerating one or more stereomers further comprises:
enumerating a stereomer with a right hand (R) state for the invertible or proto-invertible chiral atom; and
enumerating a stereomer with a left hand (S) state for the invertible or proto-invertible chiral atom.

26. The method of claim 25, wherein enumerating the one or more stereomers for the protomer further comprises:
enumerating a stereomer with the proto-invertible chiral bond in a Z state; and
enumerating a stereomer with the proto-invertible chiral bond in an E state.

27. A computer program product for identifying structures of a chemical compound comprising a set of computer instructions on a computer readable medium, wherein the set of computer instructions are executable to:
identify a protomer for further processing based on structural information for an input structure;
identify at least one invertible or proto-invertible center for the protomer from structural information associated with the protomer;
enumerate one or more proto-stereomers for the protomer based on the at least one invertible or proto-invertible center for the protomer.

28. The computer program product of claim 27, further comprising identifying at least one proto-center from the structural information for the input structure.

29. The computer program product of claim 27, wherein the protomer is a plausible protomer based on one or plausibility rules.

30. The computer program product of claim 27, wherein identifying the at least one invertible or proto-invertible center for the protomer comprises identifying an invertible or proto-invertible chiral atom.

31. The computer program product of claim 30, wherein enumerating on or more stereomers further comprises:
enumerating a stereomer with a right hand state for the invertible or proto-invertible chiral atom; and
enumerating a stereomer with a left hand state for the invertible or proto-invertible chiral atom.

32. The computer program product of claim 27, wherein identifying the at least one invertible or proto-invertible center for the protomer comprises identifying a invertible or proto-invertible chiral atom.

33. The computer program product of claim 32, wherein enumerating the one or more proto-stereomers for the protomer further comprises: enumerating a stereomer with the proto-invertible chiral bond in a Z state; and
enumerating a stereomer with the proto-invertible chiral bond in an E state.

34. A method for identifying structures of a chemical compound comprising:
receiving structural information for an input structure of a chemical compound;
identifying one or more acidic/basic atoms from the structural information;
identifying one or more true proton-donor/proton-acceptor pairs;
determining a set of plausible protomers for the chemical compound based on the acidic/basic atoms and true proton-donor/proton-acceptor pairs identified and a set of plausibility rules;
enumerating structural information for the set of plausible protomers;
identifying any invertible centers and proto-invertible centers for each of the set of plausible protomers; and
enumerating one or more proto-stereomers for each protomer of the set of plausible protomers based on the identified invertible centers and proto-invertible centers.

35. The method of claim 34, wherein the one or more proto-invertible centers comprise proto-invertible chiral atoms.

36. The method of claim 34, wherein the one or more proto-invertible centers comprise proto-invertible chiral bonds.

37. The method of claim 34, further comprising enumerating the set of stereomers for the protomer based on the one or more proto-invertible centers identified for that protomer from the set of plausible protomers.
